(19) United States
(12) Patent Application Publication
(10) Pub. No.: US 2026/0193924 A1
(43) Pub. Date: Jul. 9, 2026

(54) Pinch Protection System for Vehicle Doors

(71) Applicant: Bayerische Motoren Werke Aktiengesellschaft, Muenchen (DE)

(72) Inventors: Erik BRADEN, Muenchen (DE); Reinhard PEIS, Zolling (DE)

(21) Appl. No.: 19/134,046

(22) PCT Filed: Dec. 22, 2023
(86) PCT No.: PCT/DE2023/100990

§ 371 Date: May 29, 2025

(30) Foreign Application Priority Data
Jan. 24, 2023 (DE) 10 2023 101 715.2

(51) Int. Cl. E05F 15/40

(52) U.S. Cl. CPC E05F 15/40; E05Y 2900/531

(57) ABSTRACT

A pinch protection system of a vehicle door. The pinch protection system provides pinch protection for a region within a joint. In a closing process the vehicle door is brought into a pre-latching position and then into an end position. The system includes an operating point installed on the vehicle door where an automatic closing of the vehicle door takes place by actuation of the operating point, a sensor system for monitoring a self-closing function and an automatic soft-close system disposed at the operating point, a control device operatively connected to the operating point and the sensor system, and a pinch protection sensor system operatively connected to the control device and installed at the operating point and the joint. The control device is configured to interrupt or not start the closing process when the pinch protection sensor system detects a contact during the closing process.

### BACKGROUND AND SUMMARY

The invention relates to a pinch protection system for vehicle doors, to a method and to a vehicle.

In vehicles, in particular passenger cars, manual vehicle doors, which can be opened or closed by hand, and automatic or automated vehicle doors which open or close by means of an electric drive are known. Vehicle doors with electric drive have a multiplicity of sensors in order to detect the user's operating request, but also to detect objects in the vicinity of the vehicle door and, if necessary, to break off the opening or closing. In particular when the vehicle door is closed, it may happen that an object such as a hand or a finger is located in the joint between the vehicle door(s) and the body and is clamped when no corresponding measures are taken in order to prevent this, i.e., if no pinch protection is envisaged.

A method for anti-pinch protection is already known, for example, from DE 10 202 0 006 716 A1. However, there is still a need for improvement in the provision of pinch protection for vehicle doors.

Thus, it is an object of this invention to provide a novel and improved pinch protection system for vehicle doors.

A pinch protection system for vehicle doors is provided, which is designed to provide pinch protection for a region within a joint between a vehicle door having a self-closing function and an automatic soft-close system and another vehicle door or the vehicle body, wherein at least one automatic closing of the vehicle door is envisaged on the vehicle door, wherein the vehicle door is first brought into a pre-latching position in order then to be brought into an end position by means of the automatic soft-close system, in which control device the vehicle door is completely closed, and wherein a sensor system is envisaged for monitoring the self-closing function and the automatic soft-close system at or in the vicinity of the operating point, and wherein at least one control device is envisaged which is operatively connected to the operating point and the sensor system in order to control the closing process, and wherein a pinch protection sensor system is fitted at or in the vicinity of the operating point and in the vicinity of the joint, which is operatively connected to the control device, wherein the control device is configured to interrupt or not start the closing process when the pinch protection sensor system detects a contact during the closing process.

By providing sensors directly at or in the vicinity of the operating point, objects in the danger area of the joint between vehicle door(s) and/or body can be detected and a closing process of the vehicle door is stopped, i.e., not started or aborted.

Furthermore, it is envisaged that the control device is configured to interrupt or not start the closing process into the end position if the pinch protection sensor system detects a contact during or immediately before the bringing of the vehicle door from the pre-latching position into the end position.

Furthermore, it is envisaged that the pinch protection sensor system has a capacitive or inductive sensor or is formed as a capacitive or inductive sensor. Furthermore, it is envisaged that the pinch protection sensor system is part of the sensor system for monitoring the self-closing function and/or the automatic soft-close system.

Furthermore, it is envisaged that at least one optical display device is installed at the operating point, which is configured to optically display an execution and/or termination of the closing process.

Furthermore, it is envisaged that the display is a colored display and the execution of the closing process is displayed with a different color than a termination of the closing process.

Furthermore, a vehicle having at least one vehicle door with a self-closing function and an automatic soft-close system is provided, wherein the vehicle has the pinch protection system.

Furthermore, a method for pinch protection for a region within a joint between a vehicle door with a self-closing function and an automatic soft-close system and another vehicle door or the vehicle body is provided, wherein an operating point is installed on the vehicle door, by the actuation of which at least one automatic closing of the vehicle door takes place, wherein the vehicle door is first brought into a pre-latching position in order then to be brought into an end position by means of the automatic soft-close system in which the vehicle door is completely closed, and wherein a sensor system is fitted for monitoring the self-closing function and automatic soft-close system at or in the vicinity of the operating point, and wherein at least one control device is envisaged which is operatively connected to the operating point and the sensor system in order to control the closing process, a pinch protection sensor system is installed at or in the vicinity of the operating point and in the vicinity of the joint, which is operatively connected to the control device, wherein the closing process is terminated or not started when the pinch protection sensor system detects a contact during the closing process

Furthermore, a pinch protection sensor system is installed at or in the vicinity of the operating point and in the vicinity of the joint, which is operatively connected to the control device, wherein the closing process is terminated or not started when the pinch protection sensor system detects a contact during or immediately before bringing the vehicle door from the pre-latching position into the end position.

Further features and advantages of the invention emerge from the following description of exemplary embodiments of the invention, with reference to the figures, which shows details according to the invention, and from the claims .. The individual features can each be implemented individually or in any combination in a variant of the invention.

Preferred embodiments of the invention are explained in more detail below with reference to the attached drawings.

### BRIEF DESCRIPTION OF THE DRAWINGS

FIG. 1 shows a schematic representation of important components of the pinch protection system according to an embodiment of the present invention; and

FIGS. 2 to 4 show schematic representations of an open position, a pre-latching position and an end position of a vehicle door.

### DETAILED DESCRIPTION OF THE DRAWINGS

In the following description of the figures, identical elements or functions are envisaged with the same reference symbols.

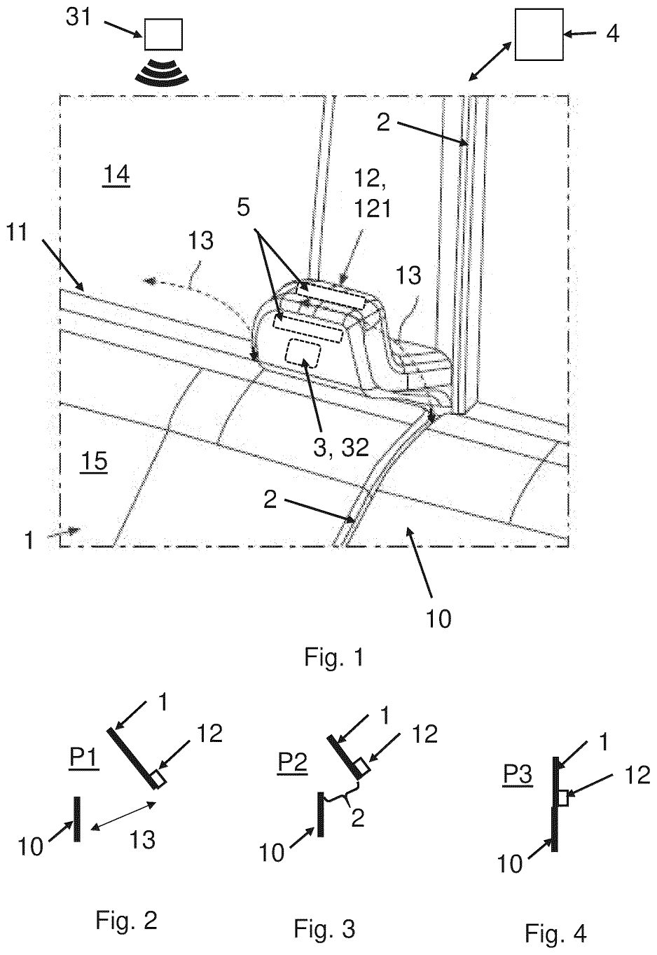

The basic concept of the invention is to provide a pinch protection system for vehicle doors 1, in which clamping of, for example, a hand or a finger of a user during the closing of the vehicle door 1 in the joint 2 between the vehicle door(s) 1 and/or the body of the vehicle is avoided as far as possible. In this case, the joint 2 can be both the joint 2 between two adjacent vehicle doors 1 (e.g., between the front and rear doors, as indicated in FIG. 1) and the joint between a vehicle door 1 and the body (e.g., between rear door and rear fender or vehicle door and rear body region, not shown in each case).

The basic prerequisite for the provided pinch protection system is that the vehicle door 1 can close at least automatically, that is to say it has a self-closing function already known in the prior art (with corresponding known actuator system, sensor system and control). It is also advantageous to provide a so-called automatic soft-close system, hereinafter also referred to as SCA, by means of which the vehicle door 1 is closed in two steps, as indicated schematically in FIGS. 2 to 4, wherein the direction of movement of the vehicle door 1 in FIG. 1 is indicated by the double arrows 13.

During the closing process, in a first step, the vehicle door 1 is brought from an open position P1 (as indicated in FIG. 2) into a pre-latching position P2, in which the vehicle door 1 is almost closed, but still a joint 2 between the vehicle door 1 and an adjacent vehicle door 10 (which does not necessarily have a self-closing function or SCA) or is present between the vehicle door 1 and the body of the vehicle, as indicated in FIG. 3. This joint 2 is so large that a human hand or a finger fits into the joint 2 and can be clamped in the joint 2 when it is completely closed. In a second step in which the SCA is active, the vehicle door 1 is then brought into an end position P3 in which it assumes a fully closed position, as indicated in FIG. 4. As already known, the automatic closing is implemented via corresponding actuators (not shown), for example via an electric drive.

The control of the closing process is advantageously carried out by means of a control device 4. This can be installed in the vicinity of the vehicle door 1 or at a different position in the vehicle. In FIG. 1, it is schematically indicated as a box outside the enlarged view of the vehicle door 1 with the operating point 12, wherein the double arrow indicates the interaction between the control device 4 and components on the vehicle door 1 (sensor system, actuator system, etc.) of the provided pinch protection system. It is essential that the control device 4 is operatively connected to the actuators and to the sensor system described below.

In addition, in order to monitor the self-closing function and the automatic soft-close system SCA, a sensor system 3 is envisaged at or in the vicinity of the operating point 12, by means of which the closing process is requested, for example by touching. The sensor system 3 serves inter alia to start the desire of the user to start a closing process (or opening process). For this purpose, for example, a capacitive or inductive sensor can be installed on a surface of the operating point 12, as indicated in FIG. 1. In addition, a further sensor system 31 can be envisaged which serves for obstacle detection so that the vehicle door does not strike against an obstacle during opening. Such sensor system 31 is frequently a radar sensor 31 (indicated in FIG. 1 as a box outside the enlarged view of the vehicle door 1 with operating point 12), which is installed, for example, on an outer region of the body, or of the vehicle door 1. By means of this sensor system 31, however, no objects can be detected which are located close to the joint 2. This can lead to an object such as a hand or a finger being clamped when the vehicle door 1 is closed, in particular during the SCA phase (transition from P2 to P3) when it is located there.

Since, in the case of an existing automatic soft-close system, the latter is frequently activated directly as soon as the pre-latching position P2 is reached, the detection of an object in the joint 2 is necessary in order to activate anti-pinch protection and to interrupt or prevent the closing of the vehicle door 1 (not to start). This is achieved according to the invention by providing a pinch protection sensor system 32 with which an object in the vicinity of the joint 2 can be detected. If this pinch protection sensor system 32 detects an object in the vicinity of the joint 2, i.e., detects a contact, the control device 4 can abort or not start the closing process (in particular the part that executes the automatic soft-close system, that is to say bringing the pre-latching position P 2 into the end position P 3).

This pinch protection sensor system 32 is advantageously a capacitive or inductive sensor or comprises such a sensor. Thus, an object can be detected both when it contacts the area where the sensor is located and when it is in a (near) distance therefrom (depending on the sensor and its detection area), both options being referred to as detecting a contact. The pinch protection sensor system 32 used for the pinch protection can also be a sensor system 3 already present for monitoring the self-closing function and automatic soft-Attorney close system, as indicated in FIG. 1, which is installed at a suitable location at or near the joint 2. Alternatively, the pinch protection sensor system 32 can be envisaged exclusively for the detection of an object at or near the joint 2. Advantageously, the sensor system is envisaged at the operating point 12 or in the vicinity of the operating point 12 and on the body or an outer region of the vehicle door 1 close to the joint 2.

In one embodiment, it is also envisaged that the operating point 12 has an optical display device 5, for example in the form of one or more light sources. These are advantageously arranged on one or more visible sides thereof, such as, for example, LEDs, as indicated in FIG. 1. This optical display device 5 serves to indicate when the closing process is aborted or is not started at all (as a warning indicator). The optical display device 5 can also serve to indicate that the closing process is carried out (as an information display). In this case, it is envisaged that the display of the optical display device 5 for the warning display is another as for the information display. For example, the light color can differ.

The operating point 12 can be designed as a handle or wing element 121. FIG. 1 shows an operating point 12 which is formed as a wing element 121 arranged above a sill 11 of the vehicle door 12 (between window region 14 and door body 15).

Of course, the vehicle door 1 can also provide an automatic opening, wherein this is not relevant to the present invention and the described pinch protection and is therefore not considered.

The pinch protection system described thus comprises an operating point 12 on a vehicle door 1 with a self-closing function and an automatic soft-close system and sensors 3, 32 arranged thereon or in the vicinity thereof, as well as a control device 4, which can control the actuator system of the closing mechanism (for self-closing function and soft-close automatic) of the vehicle door 1 and can process the sensor data obtained by the sensor system 3, 32 in such a way that they determine an abort or a non-activation of a closing function of the vehicle door 1 and can output the corresponding command to the actuator system.

The pinch protection system described is part of a vehicle, advantageously of a passenger vehicle, and is installed in the region of at least one vehicle door 1.

### LIST OF REFERENCE CHARACTERS

100 vehicle
1 Vehicle door
10 Adjacent vehicle door
11 Sill of the vehicle door
12 Operating point
121 Wing element
13 Opening direction of the vehicle door
14 Window region
15 Door body
2 Joint
3 Sensor system
31 Additional sensors, radar
32 Pinch protection sensor system, capacitive/inductive sensor
4 Control device
5 Optical display device
P1 Open position
P2 Pre-latching position, almost closed position
P3 End position

1.-9. (canceled)

10. A pinch protection system of a vehicle door, wherein the vehicle door has a self-closing function and an automatic soft-close system, wherein the pinch protection system is configured to provide pinch protection for a region within a joint between the vehicle door and another vehicle door or a body of a vehicle with the vehicle door, and wherein in a closing process of the vehicle door the vehicle door is first brought into a pre-latching position and is then brought into an end position by the automatic soft-close system, the pinch protection system comprising:
an operating point installed on the vehicle door, wherein an automatic closing of the vehicle door takes place by actuation of the operating point;
a sensor system for monitoring the self-closing function and the automatic soft-close system, wherein the sensor system is disposed at, or in a vicinity of, the operating point;
a control device which is operatively connected to the operating point and the sensor system, wherein the closing process of the vehicle door is controllable by the control device; and
a pinch protection sensor system, wherein the pinch protection sensor system is operatively connected to the control device and is installed at, or in the vicinity of, the operating point and in a vicinity of the joint;
wherein the control device is configured to interrupt or not start the closing process when the pinch protection sensor system detects a contact during the closing process.

11. The pinch protection system according to claim 10, wherein the control device is configured to interrupt or not start the closing process when the pinch protection sensor system detects a contact during or immediately before the vehicle door is brought from the pre-latching position into the end position.

12. The pinch protection system according to claim 10, wherein the pinch protection sensor system has a capacitive sensor or an inductive sensor or is formed as the capacitive sensor or the inductive sensor.

13. The pinch protection system according to claim 10, wherein the pinch protection sensor system is part of the sensor system.

14. The pinch protection system according to claim 10, wherein an optical display is disposed at the operating point and wherein the optical display is configured to optically display an execution and/or a termination of the closing process.

15. The pinch protection system according to claim 14, wherein the optical display is a colored display and wherein a performing of the closing process is displayed with a different color than a terminating of the closing process.

16. A vehicle, comprising:
a vehicle door with a self-closing function and an automatic soft-close system; and
the pinch protection system according to claim 10.

17. A method for operating a pinch protection system for a region within a joint between a vehicle door with a self-closing function and an automatic soft-close system and another vehicle door or a body of a vehicle with the vehicle door, wherein in a closing process of the vehicle door the vehicle door is first brought into a pre-latching position and is then brought into an end position by the automatic soft-close system;
wherein the pinch protection system comprises:
an operating point installed on the vehicle door, wherein an automatic closing of the vehicle door takes place by actuation of the operating point;
a sensor system for monitoring the self-closing function and the automatic soft-close system, wherein the sensor system is disposed at, or in a vicinity of, the operating point;
a control device which is operatively connected to the operating point and the sensor system, wherein the closing process of the vehicle door is controllable by the control device; and
a pinch protection sensor system, wherein the pinch protection sensor system is operatively connected to the control device and is installed at, or in the vicinity of, the operating point and in a vicinity of the joint;
and the method comprising the step of:
terminating the closing process or not started the closing process by the control device when the pinch protection sensor system detects a contact during the closing process.

18. The method according to claim 17, wherein the closing process is terminated or not started when the pinch protection sensor system detects the contact during or immediately before bringing the vehicle door from the pre-latching position into the end position.
